(19) United States
(12) Patent Application Publication
(10) Pub. No.: US 2020/0097872 A1
(43) Pub. Date: Mar. 26, 2020

(54) SYSTEMS AND METHODS FOR AUTOMATED ROLE REDESIGN

(71) Applicant: Terry Hirsch, Highland, UT (US)

(72) Inventor: Terry Hirsch, Highland, UT (US)

(21) Appl. No.: 16/582,740

(22) Filed: Sep. 25, 2019

Related U.S. Application Data
(60) Provisional application No. 62/735,892, filed on Sep. 25, 2018.

(51) Int. Cl. G06Q 10/06

(52) U.S. Cl. CPC G06Q 10/06312; G06Q 10/06315; G06Q 10/06313; G06Q 10/067

(57) ABSTRACT

A system including: at least one processor; and at least one memory having stored thereon computer program code that, when executed by the at least one processor, instructs the at least one processor to: receive user activity data including identification of historical user activity of a plurality of users of an enterprise system; receive one or more separation of duty (SoD) rulesets; automatically generate, based on the user activity data and the SoD rulesets, a plurality of roles; and assign, based on the user activity data and the SoD rulesets, one or more of the plurality of generated roles to plurality of users of the enterprise system.

### CROSS-REFERENCE TO RELATED APPLICATIONS

This application claims priority to U.S. Provisional Patent Application Ser. No. 62/735,892, which is incorporated herein by reference in its entirety as if fully set forth below.

### FIELD

The present disclosure relates generally to relates to information technology security, and more particularly to user authorization management and role redesign within an enterprise resource planning system.

### BACKGROUND

Enterprise resource planning systems (ERPs) are widely used to track data, applications, and activity rights and access. As non-limiting examples, ERPs are used to keep track of business functions, such as finances, taxes, inventory, payroll, and planning, and to allow sharing of data across organizational units.

Businesses commonly utilize ERPs within distributed computing systems that spread computational and data storage resources across computer networks to a large number of geographically separate computing nodes and corporate functions. Such distributed computing systems expose sensitive data and networks to greater risks of loss, unauthorized modification, and unauthorized access than would exists in a more centralized computing system. These risks are mitigated, in part, by creating security profiles (e.g., roles) that specify what actions or activity tasks an assigned user is allowed to perform. One or more security profiles are then assigned to each user, usually in accordance with a user's position or job duties. To limit potential breach, certain tasks (e.g., activities) are supposed to be assigned to different users. For example, in some organizations, a same user may not be able to request a funds transfer and release the funds.

One of ordinary skill would recognize SAP produced by SAP AG, Walldorf, Germany as a widely used ERP system. In SAP, security profiles are called “roles,” and have transaction codes that describe the actions available to a given role. In SAP, organizations define Segregation of Duties Rulesets (SoDs) that state no one individual or role should have the physical and system access to control end-to-end phases of a business process or transaction (e.g., creating and adjusting an invoice, creating a vendor and initiating payments, processing inventory and posting payment authorization). This separation effectively reduces the associated risk of fraud and error.

As a company grows or an organization and its employees change, system administrators become unable to effectively create, assign, and monitor security profiles to members of the organization. Rather, it becomes almost impossible to exercise control over security in such an environment without unreasonably hindering access to the database system. Thus, users are commonly granted right far beyond the required scope, and SoD conflicts (i.e., SOD violations) are common. As a result, system security is compromised. This over-subscription can also result in unnecessary licensing fees, for functions or applications that are licensed on a per user basis. Further, over time, new roles are added, which creates a bloating of potential issues, confusion as to role designations, redundancy of roles, and SoD conflicts within roles and users.

In the related art, manual role analysis and redesign are regularly required to minimize the impact of these and other issues. Given the scope of the project, manual role design requires multiple resources (often external consultants) and may take over a year to complete. This process is drawn out, creates anxiety with users as they are unsure how their access will change, and can be unduly expensive. Moreover, as redesigns are a point-in-time solution, redesigns degrade over time, and must be repeated periodically to limit the return of SoD conflicts and poor role management.

Accordingly, there is a need for improved systems and methods that may provide improved role redesign processes. Such improvements may improve system security, reduce processing overhead, and provide enhanced security tracking. Aspects of the present disclosure relate to these and other issues.

### SUMMARY

Briefly described, and according to an embodiment, aspects of the present disclosure generally relate to a system including: at least one processor; and at least one memory having stored thereon computer program code that, when executed by the at least one processor, instructs the at least one processor to: receive user activity data including identification of historical user activity of a plurality of users of an enterprise system; receive one or more separation of duty (SoD) rulesets; automatically generate, based on the user activity data and the SoD rulesets, a plurality of roles; and assign, based on the user activity data and the SoD rulesets, one or more of the plurality of generated roles to plurality of users of the enterprise system.

Briefly described, and according to an embodiment, aspects of the present disclosure generally relate to a method including: receiving user activity data including identification of historical user activity of a plurality of users of an enterprise system; receiving one or more separation of duty (SoD) rulesets; automatically generating, based on the user activity data and the SoD rulesets, a plurality of roles; and assigning, based on the user activity data and the SoD rulesets, one or more of the plurality of generated roles to plurality of users of the enterprise system.

The method may further include: assigning, based on the user activity data and the SoD rulesets, one or more of the plurality of generated roles to a plurality of test users, respective test users of the plurality of test users corresponding to respective users of the plurality of users of the enterprise system; and testing the plurality of generated roles assigned to the plurality of test users.

15. The method may further include: recreating a production environment of the enterprise system; placing the test users in the recreated production environment; and providing access to one or more user devices to control the test users in the recreated production environment.

16. The method may further include assigning the one or more of the plurality of generated roles to the plurality of users of the enterprise system by provisioning the tested assigned plurality of generated roles from the test users to respective users of the plurality of users of the enterprise system.

The method may further include: recreating a production environment of the enterprise system; placing the test users in the recreated production environment; retrieving subsequent user activity of the plurality of users of the enterprise system in the production environment; and replaying, with the corresponding test users in the recreated production environment, the subsequent user activities.

The method may further include: recreating a production environment of the enterprise system; placing the test users in the recreated production environment; and replaying, with the corresponding test users in the recreated production environment, the historical user activity of the plurality of users of the enterprise system.

Automatically generating the plurality of roles may include transforming the user activity data and the SoD rulesets into the plurality of roles.

The method may further include: naming a plurality of roles; and assigning, based on the user activity data and the SoD rulesets, one or more activities to each of the plurality of roles.

The assigned one or more of the plurality of generated roles may include identifying subsequent user activities of the plurality of users of the enterprise system in the production environment; and comparing the subsequent user activities to the assigned one or more activities of the assigned one or more of the plurality of generated roles.

The method may further include utilizing machine-learning algorithms to analyze the user activity data and the SoD rulesets to generate the plurality of roles.

Utilizing the machine-learning algorithms may include: analyzing existing role definitions to determine naming and format conventions; analyzing SoD rulesets to determine second-level restrictions; and generating the plurality of roles in accordance with the determined naming and format conventions and second-level restrictions.

The method may further include: receiving legacy role definitions and legacy role assignments of the plurality of users of the enterprise system; storing the legacy role definitions and legacy role assignments; and in response to a user indication, reverting the assigned roles of the plurality of users of the enterprise system to the legacy role assignments.

The method may further include: generating an emergency repair role; identifying, from within the user activity data, one or more activities that are historically used less than a predetermined number of times; and assigning the identified one or more activities to the emergency repair role.

Briefly described, and according to an embodiment, aspects of the present disclosure generally relate to non-transitory computer readable medium having stored thereon computer program code for executing one or more of the above-described methods.

### BRIEF DESCRIPTION OF THE DRAWINGS

Reference will now be made to the accompanying drawings, which are incorporated into and constitute a portion of the present disclosure. The drawings may illustrate certain aspects of the disclosed technology, and, together with the description, may explain the principles of the disclosed technology. In the drawings:

FIG. 1 illustrates an example environment in which one or more aspects of the present disclosure may be implemented.

FIG. 2 is a flowchart of an automated role redesign method according to an example embodiment.

FIG. 3 is a flowchart of an automated role redesign method according to another example embodiment.

FIG. 4 is a flow chart of role redesign configuration according to an example embodiment.

FIG. 5 is a block diagram of an illustrative computer system architecture, according to an example implementation.

### DETAILED DESCRIPTION

Certain features of one or more example embodiments are described below with reference to one or more figures. It will be understood by one of ordinary skill that many alterations may be made to the described embodiments without departing from the scope of the present disclosure.

In some example embodiments, there may be provided a system or method that performs role (e.g., security profile) redesign in an automated fashion. The system may analyze user activity data, existing security and authorization information, an organization's SoDs, and the organization's current role definitions and assignments. Based on these features, the system can automatically generate roles that comply with the organization's SoDs, and automatically assign roles to users based on actual user activity. In some implementations, the system may provide one or more of testing, role configuration, and role reversion.

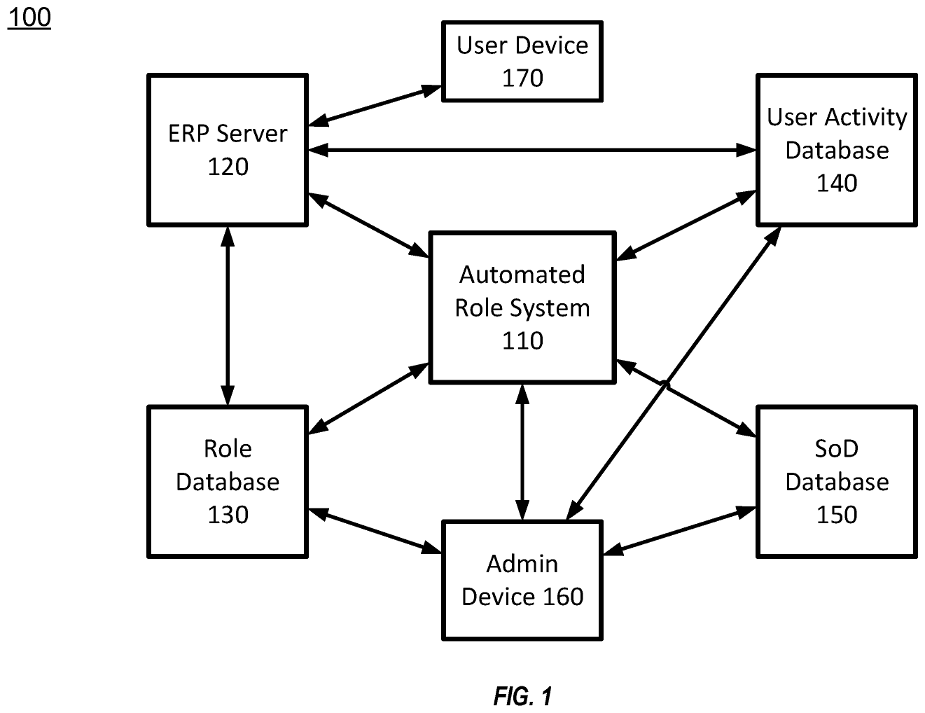

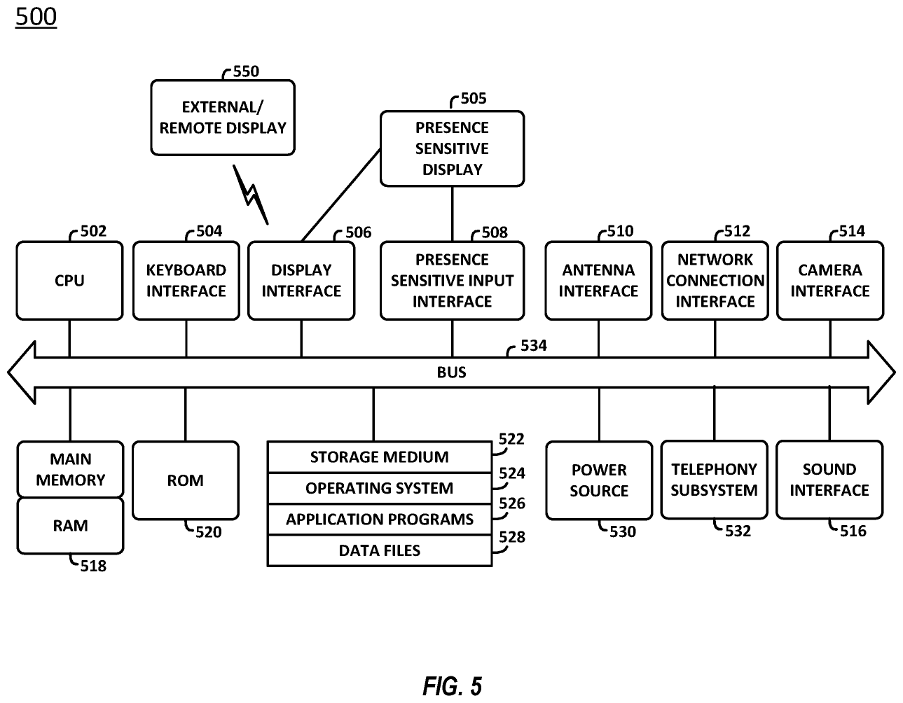

FIG. 1 illustrates an example environment 100 in which one or more aspects of the present disclosure may be implemented. The example environment includes an automated role system 110, an ERP server 120, a role database 130, a user activity database 140, an SoD database 150, admin device 160, and user device 170. One or more of automated role system 110, ERP server 120, role database 130, user activity database 140, SoD database 150, admin device 160, and user device 170 may be implemented within one or more computer system architectures, for example, as described below with reference to FIG. 5.

Automated role system 110 communicates with role database 130, user activity database 140, SoD database 150, and admin device 160. In some cases, automated role system 110 extracts the user activity (e.g., transaction code usage) from user activity database 140, role definitions and assignments from role database 130, and SoD rulesets from SoD database 150. Automated role system 110 may receive configuration instructions from admin device 160. Automated role system 110 can perform role redesign, for example, by creating new conflict-free roles assigned to users based on respective user activity. In other words, the individual users may have SoD conflicts by virtue of the assigned roles, but no single role will have an SoD conflict. Automated role system 110 transports the new roles and role assignments to role database 130, completing the redesign.

In some embodiments, automated role system 110 may assign roles to test users (corresponding to actual users), and the test user roles may be tested automatically and/or manually through inputs from admin device 160. For example, before roles are assigned to users, automated role system 110 may track user activities (e.g., through communication with ERP server 120) under the original role regime, and may determine any actions that could not be completed with the redesigned roles. In an embodiment, the redesigned roles may be automatically modified to allow such actions. In an embodiment, such actions may be compiled and reported for review or otherwise provided for as exceptions in the redesigned roles. In some implementations, automated role system 110 provides one or more of role reversion (e.g., reverting to previous roles and assignments), monitoring (e.g., transaction tracking after redesign and role simulation on a user level), and role design changes (e.g., modifications to roles, role assignments, and SoD rulesets).

ERP server 120 may maintain an organization's enterprise systems. In some cases, ERP server 120 may provide user activity logs (e.g., transaction codes) to user activity database 140. In some implementations, automated role system 110 may control ERP server 120 to provide the user activity logs to user activity database 140. ERP server 120 may communicate with role database 130 to limit users to designated functions. For instance, a user logs-in to an organization's enterprise systems through a connection between user device 170 and ERP server 120. The ERP server 120 limits the user's access in accordance with the role assignments to the user-defined in the role database 130.

Role database 130 may include role definitions and assignments (e.g., user role assignments). In some cases, admin device 160 may provide defined roles and assignments and provide the same to role database 130. In some implementations, automated role system 110 may access and modify active roles and role assignments. In some cases, role database 130 may store legacy roles and legacy assignments, which may be reactivated or reapplied by automated role system 110.

User activity database 140 stores records of user actions in the enterprise systems. For example, user activity database 140 may be a transaction archive. The records may include one or more transaction codes (of user activities), action descriptions, and/or access points. User activity database 140 may receive the records (e.g., activity logs or transaction calls) from ERP server 120. User activity database 140 may provide the records to automated role system 110 to perform role redesign and analysis. The use of user activity records or data enables the system 100 to tie role redesign and role assignment to how individuals and/or groups of users actually use the enterprise resources. This provides the dual benefits of 1) increasing ease of use of the users, and 2) minimizing guesswork required by role design based on predicted use.

SoD database 150 includes definitions of SoD rulesets. The SoD rulesets identify sets of duties (e.g., transaction codes or activities) that should not be performed by a single user. SoD database 150 may receive the SoD rules from admin device 160 (e.g., from an administrator accessing admin device 160). SoD database 150 provides the SoD rulesets to automated role system 110 for role redesign and analysis.

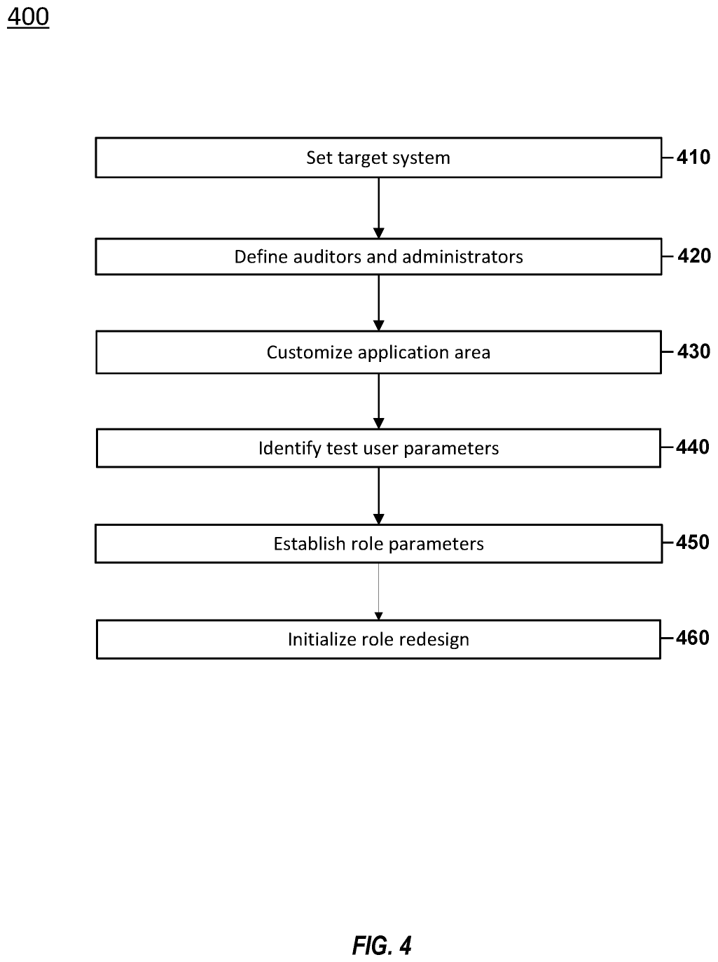

Admin device 160 may be a standard or customized computing device capable of accessing or communicating with various elements of environment 100. In some cases, admin device 160 may utilize a log-in portal to adjust role descriptions and assignments in role database 130, view or modify SoD rulesets in SoD database 150, and review user activity in user activity database 140. Admin device 160 may communicate with automated role system 110 to direct role redesign. For example, in some cases, admin device 160 may perform redesign configuration, as discussed in more detail below with reference to FIG. 4. In some cases, admin device 160 may access ERP server 120 to initiate a transaction archive, thereby initiating storage of user activity logs in user activity database 140.

User device 170 may be a standard or customized computing device capable of accessing or communication with various elements of environment 100. User device 170 may interact with ERP server 120 to access enterprise systems (e.g., through a web-portal).

Although automated role system 110, ERP server 120, role database 130, user activity database 140, SoD database 150, admin device 160, and user device 170 may be physically separate devices, this is merely an example and, in some implementations, one or more of automated role system 110, ERP server 120, role database 130, user activity database 140, SoD database 150, admin device 160, and user device 170 may be combined within one or more physical or virtual devices. In some cases, elements and functions of one or more of automated role system 110, ERP server 120, role database 130, user activity database 140, SoD database 150, admin device 160, and user device 170 may be combined and rearranged in one or more devices as would be understood by one of ordinary skill.

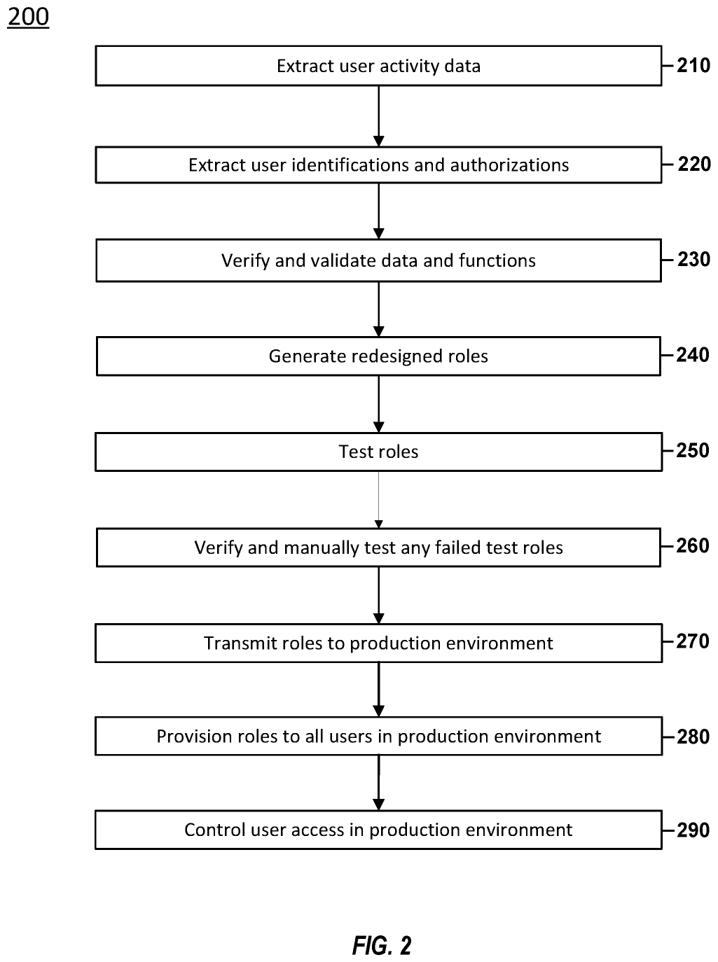

FIG. 2 is a flowchart 200 of a role redesign method according to an example embodiment. As a non-limiting example, the method may be performed by automated role system 110. At 210, automated role system 110 extracts user activity data. For example, automated role system 110 accesses user activity database 140 and extracts transaction codes of user activities of users (e.g., all users) of an enterprise system. In some implementations, automated role system 110 may track or otherwise gather the user activity data over time. At 220, automated role system 110 extracts user identifications and authorizations from role database 130. In some cases, automated role system 110 extracts role definitions and role assignments for each user. Automated role system 110 may also extract SoD rulesets from SoD database 150.

At 230, automated role system 110 may verify data and functions. For example, certain functions (e.g., transaction codes) may be bundled such that either all or none of the bundled functions may be assigned to a given role.

At 240, automated role system 110 generates redesigned roles. The role redesign may leverage production environment data (e.g., user activity logs and SoD rulesets) to build and assign roles. In other words, automated role system 110 may transform production environment data (i.e., the user activity logs and SoD rulesets) into newly functional data for guiding future system interactions.

In some implementations, machine-learning or other artificial intelligence processes may perform the role redesign process. For example, automated role system 110 machine-learning algorithms may analyze existing role definitions to determine naming and format conventions and utilize the naming and format conditions to define and name new roles. Automated role system 110 machine-learning algorithms may analyze SoD rulesets to determine intended functional limitations, and derive second-level restrictions (e.g., implicit or buffer restrictions) therefrom. For example, if SoD rulesets indicate that a same role should not be able to create a merchant and authorize merchant payments, automated role system 110 may avoid defining new roles that have similar functionality (e.g., adding employees and authorizing employee payments). Accordingly, the system can automatically create a buffer around defined SoD rulesets without interfering with ERP system use.

In some cases, automated role system 110 generates new conflict-free single roles, and assigns the roles to test users (e.g., corresponding to actual users). The automated role system 110 may utilize SoD rulesets, current roles and role assignments, and actual user activity in the role redesign. Activities (e.g., transaction codes) that are used less than a predetermined number of times may not be assigned to any standard role. Rather, these transaction codes may be assigned to an Emergency Repair (ER) role. Accordingly, additional oversight may be maintained for rare activities. In some instances, legacy role definitions (e.g., assigned functions, transaction codes, or activities before the redesign) may violate an SoD rule. A less-used of the conflicting functions may be assigned to the ER role. For example, if a single role includes creating a vendor and approving payment to the vendor, creating a vendor may be assigned to the ER role as vendor creation is less common than vendor payment.

At 250, automated role system 110 tests the generated roles. As a non-limiting example, automated role system 110 may compare redesigned roles to the SoD rulesets to ensure no single roles violate an SoD. In some cases, automated role system 110 may recreate a production environment (e.g., “dummy” or sandboxed environment), create test users, assign roles to the test users, and allow testers (e.g., using user device 170 or admin device 160) to interact with the system as a corresponding test user. Test users may correspond, one-to-one, to actual users in a production environment. In some cases, activities in the recreated production environment may be persisted by the automated role system 110 if committed by the users (e.g., activities of a test user in the recreated environment may be performed in the production environment as if done by a corresponding actual user).

In some implementations, automated role system 110 may recreate the production environment and execute user actions for corresponding test users. For instance, automated role system 110 may access user activity database 140 or ERP Server 120 to detect user activities (e.g., in real-time, near-real-time, batch, or historic) using the legacy role models and assignments. These user activities may be replayed by corresponding test users in the recreated environment to detect any limitations in the new roles (e.g., any user activities that would no longer be enabled with the redesigned roles). In response to the detected limitations, automated role system 110 may, for example, reassign roles to users to overcome the limitations, modify the redesigned roles to overcome the limitations, create exceptions to the new roles to overcome the limitations for specific users, and/or notify an administrator of the limitations.

In some cases, at 260, an administrator (e.g., admin device 160) may verify allowed activities for users (e.g., legacy versus redesigned), and review any failed or invalid activities (e.g., transaction codes). In some cases, automated role system 110 may generate various reports or flag various items for administrator review. For example, automated role system 110 may report on role status (e.g., number of roles, number of role assignments, number of assignments per role), user-based role design (e.g., any conflicts between attempted user actions, the legacy role set, and the redesigned role set), and activity failure report (e.g., failed transactions).

At 270, automated role system 110 transmits the roles to the production environment and, at 280, provisions the roles to all users within the production environment. For example, automated role system 110 may update role database 130 to reflect definitions for the newly generated roles and for role assignments for each user. In some cases, the legacy roles may be maintained as a back-up to the newly created roles, and automated role system 110 may enable reversion back to the previous roles by controlling the role database 130.

At 290, the provisioned roles control user access within the production environment. These newly provisioned roles may control what information within the production environment that a user may see, and what actions within the production environment that the user may perform. For example, a user may be prevented from performing a restricted action that is not allowed by the definitions of their newly assigned roles. In some cases, a user may have been authorized to perform an action under the legacy role system, but, with the newly assigned roles, this action may only be performed using an emergency role.

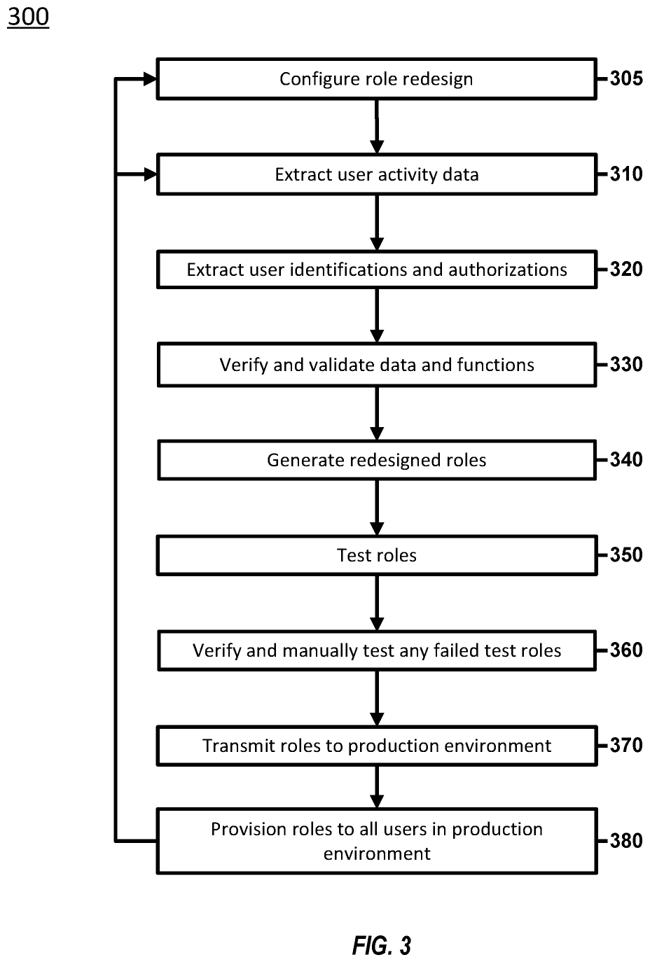

FIG. 3 is a flowchart 300 of a role redesign method according to an example embodiment. At 305, role redesign is configured. As a non-limiting example, automated role system 110 may provide a graphical user interface (GUI) for an administrator using admin device 160 to input or review configuration instructions. In some cases, role redesign configuration may include adjustment of different parameters or conditions for different types of roles (e.g., unused/unassigned roles, unused transactions or functions within roles, and roles with SoD violations). Certain parameters may include a risk dimension (e.g., setting different parameters for roles or functions classified as high, medium, or low risk), time dimension (e.g., removing roles, or functions within roles, where the role/function has not been assigned/used within a certain time period), whether old roles or functions should be archived or deleted, redesign reports (e.g., analysis on why certain roles/functions were defined and/or assigned), usage dimension (e.g., different parameters based on frequency with which roles or functions of an SoD conflict are executed), mitigation dimension (e.g., different parameters based on whether an SoD conflict can be mitigated), and proliferation dimension (e.g., different parameters based on number of users that have a same SoD violation or are assigned a same role containing an SoD violations).

Following configuration, automated role system 110 may extract user activity, extract user identifications and authorizations, verify and validate data and functions, generate redesigned roles, test roles assigned to test used, verify and manually test any failed test roles, transmit role to product environment and provision roles to all users in the production environment at 310-380. The method portions at 310-380 may be substantially similar to the corresponding portions discussed in FIG. 2 at 210-280. Role redesign may be repeated iteratively and/or periodically as desired. In some cases, the repeated role redesign may use a same configuration or require new configuration.

The redesigned roles may minimize SoD conflicts in the production environment. For example, no single redesigned role may have an SoD conflict. Furthermore, user-based SoD conflicts (e.g., users who have authorizations with violate SoD rulesets) may be minimized. In some test implementations, SoD conflicts were reduced by 95%.

Additionally, a number of roles and user assignments may be reduced by the role redesign. For example, as a system grows and changes, repetitive roles may be defined, and certain roles may be assigned to few or no individuals. Thus, the automated role redesign may reduce this inefficiency by combining and/or eliminating manually defined roles. Similarly, as users' work or responsibilities change, additional roles may be assigned to a user. With a high level of assignment, it may be difficult to determine what activities a user actually performs or requires. Furthermore, as discussed above, many assigned roles may not be utilized by a user. Accordingly, after role-redesign, the automated roles and their corresponding functions may be assigned to users in an efficient manner. For example, in a test implementation, a number of role assignments was reduced by approximately 75%.

The assigned roles may be tied to how users actually use the enterprise resource systems. For example, after the role redesign, most (or all) users will continue to be able to access all resources and perform all functions that they previously used. Some exceptions may be made for processes identified in, for example, redesign configuration, SoD rulesets, or actions below a certain user threshold. As a result, the overall security and functionality of the system may be improved.

Moreover, the redesign may prevent over-assignment of user access. For example, certain licensed environments or actions may be licensed on a per-user basis. If the role redesign process determines that certain users have access to, but never utilize, a particular licensed function (e.g., are authorized to perform the activity), the redesigned role for the user may not include the licensed function. Therefore, in some cases, this may additionally lead to reduced licensing fees.

In some cases, roles definitions may remain unchanged after role redesign. Rather, automated role system 110 may reassign existing roles to users to minimize SoD conflicts and minimize over-subscription. In some implementations, roles created after role redesign will be analyzed within the context of the redesigned roles. For example, if an administrator using admin device 160 manually creates a new role that is either redundant to one or more redesigned roles or includes an SoD conflict, automated role system 110 may notify the administrator of the potential flaw. In some cases, automated role system 110 may provide suggestions for overcoming the flaw (e.g., what role or combination of roles to use instead of the manually created role). In some cases, an administrator using admin device 160 may manually modify redesigned roles. Automated role system 110 may notify the administrator of any potential issues (e.g., redundancy or SoD conflicts) with the modification, as well as suggest different roles or role combinations that may achieve the desired results.

FIG. 4 is a flowchart 400 of a role redesign configuration method according to an example embodiment. As a non-limiting example, the method may be performed by admin device 160. At 410, admin device 160 sets the target system. For example, admin device 160 connects (or otherwise designates) role database 130, user activity database 140, and SoD database 150 to automated role system 110 so that automated role system 110 may access the roles, role assignments, SoD rulesets, and user activity for role redesign. In some cases, admin device 160 may provide role assignments, SoD rulesets, and user activity directly to automated role system 110.

At 420, admin device 160 defines auditors and/or administrators. For example, admin device 160 may designate particular users as “administrators” for review and modification of the automated role redesign. At 430, admin device 160 customizes the application area. In some cases, automated role system 110 may direct the role redesign to specific users, specific enterprise applications, or to specific activities (e.g., financial activities).

At 440, admin device 160 defines test user parameters. For instance, the parameters may include identifying users for whom corresponding test users should be designated, defining test user naming conventions, or providing a maximum number of test users. In some implementations, admin device 160 may configure an ER role (e.g., define rules for assigning functions to an ER role). At 450, admin device 160 establishes role parameters. For example, admin device 160 may define role naming conventions or variables. Furthermore, in some cases, admin device 160 may place limits or requirements on the role redesign (e.g., certain legacy roles must be maintained, or certain users must be able to perform particular activities). At 460, admin device 160 initiates role redesign.

In some implementations, admin device 160 may participate (or have the opportunity to influence) role redesign during the role redesign process. For example, during role redesign, admin device 160 may fine-tune generated role naming conventions, function bundling, review testing analysis, and control manual testing.

FIG. 5 is a block diagram of an illustrative computer system architecture 500, according to an example implementation. The computer system architecture 500 may be used to implement one or more example embodiments within the scope of the present disclosure. In some cases, one or more elements of the computer system architecture 500 may be combined to embody one or more of automated role server 110, role database 130, user activity database 140, SoD database 150, admin device 160, and user device 170. It will be understood that the computing device architecture 500 is provided for example purposes only and does not limit the scope of the various implementations of the present disclosed systems, methods, and computer-readable mediums.

The computing device architecture 500 of FIG. 5 includes a central processing unit (CPU) 502, where computer instructions are processed, and a display interface 504 that acts as a communication interface and provides functions for rendering video, graphics, images, and texts on the display. In certain example implementations of the disclosed technology, the display interface 504 may be directly connected to a local display, such as a touch-screen display associated with a mobile computing device. In another example implementation, the display interface 504 may be configured for providing data, images, and other information for an external/remote display 550 that is not necessarily physically connected to the mobile computing device. For example, a desktop monitor may be used for minoring graphics and other information that is presented on a mobile computing device. In certain example implementations, the display interface 504 may wirelessly communicate, for example, via a Wi-Fi channel or other available network connection interface 512 to the external/remote display 550.

In an example implementation, the network connection interface 512 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 504 may be operatively coupled to a local display, such as a touch-screen display associated with a mobile device. In another example, the display interface 504 may be configured to provide video, graphics, images, text, other information, or any combination thereof for an external/remote display 550 that is not necessarily connected to the mobile computing device. In one example, a desktop monitor may be used for minoring or extending graphical information that may be presented on a mobile device. In another example, the display interface 504 may wirelessly communicate, for example, via the network connection interface 512 such as a Wi-Fi transceiver to the external/remote display 550.

The computing device architecture 500 may include a keyboard interface 506 that provides a communication interface to a keyboard. In one example implementation, the computing device architecture 500 may include a presence-sensitive display interface 508 for connecting to a presence-sensitive display 507. According to certain example implementations of the disclosed technology, the presence-sensitive display interface 508 may provide a communication interface to various devices such as a pointing device, a touch screen, a depth camera, etc. which may or may not be associated with a display.

The computing device architecture 500 may be configured to use an input device via one or more of input/output interfaces (for example, the keyboard interface 506, the display interface 504, the presence sensitive display interface 508, network connection interface 512, camera interface 514, sound interface 516, etc.) to allow a user to capture information into the computing device architecture 500. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 500 or may be a separate device. For example, the input device may be an accelerometer, a magnetometer, a digital camera, a microphone, and an optical sensor.

Example implementations of the computing device architecture 500 may include an antenna interface 510 that provides a communication interface to an antenna; a network connection interface 512 that provides a communication interface to a network. As mentioned above, the display interface 504 may be in communication with the network connection interface 512, for example, to provide information for display on a remote display that is not directly connected or attached to the system. In certain implementations, a camera interface 514 is provided, which acts as a communication interface and provides functions for capturing digital images from a camera. In certain implementations, a sound interface 516 is provided as a communication interface for converting sound into electrical signals using a microphone and for converting electrical signals into sound using a speaker. According to example implementations, a random-access memory (RAM) 518 is provided, where computer instructions and data may be stored in a volatile memory device for processing by the CPU 502.

According to an example implementation, the computing device architecture 500 includes a read-only memory (ROM) 520 where invariant low-level system code or data for basic system functions such as basic input and output (I/O), startup, or reception of keystrokes from a keyboard are stored in a non-volatile memory device. According to an example implementation, the computing device architecture 500 includes a storage medium 522 or other suitable type of memory (e.g., such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an example implementation, the computing device architecture 500 includes a power source 530 that provides an appropriate alternating current (AC) or direct current (DC) to power components.

According to an example implementation, the computing device architecture 500 includes a telephony subsystem 532 that allows the device 500 to transmit and receive sound over a telephone network. The constituent devices and the CPU 502 communicate with each other over a bus 534.

According to an example implementation, the CPU 502 has appropriate structure to be a computer processor. In one arrangement, the CPU 502 may include more than one processing unit. The RAM 518 interfaces with the computer bus 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 in order to execute software programs. Data may be stored in the RAM 518, where the data may be accessed by the computer CPU 502 during execution.

The storage medium 522 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 522, which may include a machine-readable storage medium.

According to one example implementation, the term computing device, as used herein, may be a CPU, or conceptualized as a CPU (for example, the CPU 502 of FIG. 5). In this example implementation, the computing device (CPU) may be coupled, connected, and/or in communication with one or more peripheral devices, such as display. In another example implementation, the term computing device, as used herein, may refer to a mobile computing device such as a smart phone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, computer program code may be configured to control a computer device, e.g., the computer system architecture 500, to implement one or more components of one or more embodiments. According to some implementations, computer program code may be configured to control a computer device implement one or more methods within the scope of the present disclosure.

Although some example embodiments described herein have been described in language specific to computer structural features, methodological acts, and by computer readable media (e.g., non-transitory computer readable media), it is to be understood that the disclosure is not necessarily limited to the specific structures, acts or media described. Therefore, the specific structural features, acts and mediums are disclosed as example embodiments implementing the disclosure. The present disclosure is intended to cover various modifications and equivalent arrangements including those within the scope of the appended claims and their equivalents. Although specific terms are employed herein, they are used in a generic and descriptive sense only and not for purposes of limitation.

Although example embodiments of the present disclosure described herein are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which shall have no influence on the scope of the present disclosure.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, certain terminology has been resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps or blocks of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

The following characterizing clauses are further provided as additional description of the disclosed invention. The inclusion of reference numbers is the following clauses is to facilitate understanding of an exemplary embodiment but should not be considered limiting in any way.

1. A system including: at least one processor; and at least one memory having stored thereon computer program code that, when executed by the at least one processor, instructs the at least one processor to: receive user activity data including identification of historical user activity of a plurality of users of an enterprise system; receive one or more separation of duty (SoD) rulesets; automatically generate, based on the user activity data and the SoD rulesets, a plurality of roles; and assign, based on the user activity data and the SoD rulesets, one or more of the plurality of generated roles to plurality of users of the enterprise system.

2. The system of clause 1, wherein the computer program code, when executed by the at least one processor, further instructs the at least one processor to: assign, based on the user activity data and the SoD rulesets, one or more of the plurality of generated roles to a plurality of test users, respective test users of the plurality of test users corresponding to respective users of the plurality of users of the enterprise system; and test the plurality of generated roles assigned to the plurality of test users.

3. The system of clause 2, wherein the computer program code, when executed by the at least one processor, further instructs the at least one processor to: recreate a production environment of the enterprise system; place the test users in the recreated production environment; and provide access to one or more user devices to control the test users in the recreated production environment.

4. The system of clause 3, wherein the computer program code, when executed by the at least one processor, further instructs the at least one processor to: assign the one or more of the plurality of generated roles to the plurality of users of the enterprise system by provisioning the tested assigned plurality of generated roles from the test users to respective users of the plurality of users of the enterprise system.

5. The system of clause 2, wherein the computer program code, when executed by the at least one processor, further instructs the at least one processor to: recreate a production environment of the enterprise system; place the test users in the recreated production environment;

retrieve subsequent user activity of the plurality of users of the enterprise system in the production environment; and replay, with the corresponding test users in the recreated production environment, the subsequent user activities.

6. The system of clause 2, wherein the computer program code, when executed by the at least one processor, further instructs the at least one processor to: recreate a production environment of the enterprise system; place the test users in the recreated production environment; and replay, with the corresponding test users in the recreated production environment, the historical user activity of the plurality of users of the enterprise system.

7. The system of any of clauses 1-6, wherein the computer program code includes machine-learning algorithms configured to analyze the user activity data and the SoD rulesets and generate the plurality of roles.

8. The system of clause 7, wherein the machine-learning algorithms are further configured to: analyze existing role definitions to determine naming and format conventions; analyze SoD rulesets to determine second-level restrictions; and generate the plurality of roles in accordance with the determined naming and format conventions and second-level restrictions.

9. The system of any of clauses 1-8, wherein the computer program code, when executed by the at least one processor, further instructs the at least one processor to: receive legacy role definitions and legacy role assignments of the plurality of users of the enterprise system; store the legacy role definitions and legacy role assignments; and in response to a user indication, revert the assigned roles of the plurality of users of the enterprise system to the legacy role assignments.

10. The system of any of clauses 1-9, wherein the computer program code, when executed by the at least one processor, further instructs the at least one processor to: generate an emergency repair role; identify, from within the user activity data, one or more activities that are historically used less than a predetermined number of times; and assign the identified one or more activities to the emergency repair role.

11. The system of any of clauses 1-10, wherein automatically generating the plurality of roles includes: naming a plurality of roles; and assigning, based on the user activity data and the SoD rulesets, one or more activities to each of the plurality of roles.

12. The system of clause 11, wherein the computer program code, when executed by the at least one processor, further instructs the at least one processor to test the assigned one or more of the plurality of generated roles by: identifying subsequent user activities of the plurality of users of the enterprise system in the production environment; and comparing the subsequent user activities to the assigned one or more activities of the assigned one or more of the plurality of generated roles.

13. A method including: receiving user activity data including identification of historical user activity of a plurality of users of an enterprise system; receiving one or more separation of duty (SoD) rulesets; automatically generating, based on the user activity data and the SoD rulesets, a plurality of roles; and assigning, based on the user activity data and the SoD rulesets, one or more of the plurality of generated roles to plurality of users of the enterprise system.

14. The method of clause 13 further including: assigning, based on the user activity data and the SoD rulesets, one or more of the plurality of generated roles to a plurality of test users, respective test users of the plurality of test users corresponding to respective users of the plurality of users of the enterprise system; and testing the plurality of generated roles assigned to the plurality of test users.

15. The method of clause 14 further including: recreating a production environment of the enterprise system; placing the test users in the recreated production environment; and providing access to one or more user devices to control the test users in the recreated production environment.

16. The method of clause 15 further including assigning the one or more of the plurality of generated roles to the plurality of users of the enterprise system by provisioning the tested assigned plurality of generated roles from the test users to respective users of the plurality of users of the enterprise system.

17. The method of clause 14 further including: recreating a production environment of the enterprise system; placing the test users in the recreated production environment; retrieving subsequent user activity of the plurality of users of the enterprise system in the production environment; and replaying, with the corresponding test users in the recreated production environment, the subsequent user activities.

18. The method of clause 14 further including: recreating a production environment of the enterprise system; placing the test users in the recreated production environment; and replaying, with the corresponding test users in the recreated production environment, the historical user activity of the plurality of users of the enterprise system.

19. The method of any of Clauses 13-18, wherein automatically generating the plurality of roles includes transforming the user activity data and the SoD rulesets into the plurality of roles.

20. The method of any of clauses 13-19 further including: naming a plurality of roles; and assigning, based on the user activity data and the SoD rulesets, one or more activities to each of the plurality of roles.

21. The method of clause 20, wherein assigned one or more of the plurality of generated roles includes identifying subsequent user activities of the plurality of users of the enterprise system in the production environment; and comparing the subsequent user activities to the assigned one or more activities of the assigned one or more of the plurality of generated roles.

22. The method of any of clauses 13-21 including utilizing machine-learning algorithms to analyze the user activity data and the SoD rulesets to generate the plurality of roles.

23. The method of clause 22, wherein utilizing the machine-learning algorithms includes: analyzing existing role definitions to determine naming and format conventions; analyzing SoD rulesets to determine second-level restrictions; and generating the plurality of roles in accordance with the determined naming and format conventions and second-level restrictions.

24. The method of any of clauses 1-23 further including: receiving legacy role definitions and legacy role assignments of the plurality of users of the enterprise system; storing the legacy role definitions and legacy role assignments; and in response to a user indication, reverting the assigned roles of the plurality of users of the enterprise system to the legacy role assignments.

25. The method of any of clauses 1-24 further including: generating an emergency repair role; identifying, from within the user activity data, one or more activities that are historically used less than a predetermined number of times; and assigning the identified one or more activities to the emergency repair role.

26. A non-transitory computer readable medium having stored thereon computer program code for executing the method of any of clauses 1-25.

What is claimed is:

1. A system comprising:
at least one processor; and
at least one memory having stored thereon computer program code that, when executed by the at least one processor, instructs the at least one processor to:
receive user activity data including identification of historical user activity of a plurality of users of an enterprise system; receive one or more separation of duty (SoD) rulesets;
automatically generate, based on the user activity data and the SoD rulesets, a plurality of roles; and
assign, based on the user activity data and the SoD rulesets, one or more of the plurality of generated roles to plurality of users of the enterprise system.

2. The system of claim 1, wherein the computer program code, when executed by the at least one processor, further instructs the at least one processor to:
assign, based on the user activity data and the SoD rulesets, one or more of the plurality of generated roles to a plurality of test users, respective test users of the plurality of test users corresponding to respective users of the plurality of users of the enterprise system; and
test the plurality of generated roles assigned to the plurality of test users.

3. The system of claim 2, wherein the computer program code, when executed by the at least one processor, further instructs the at least one processor to:
recreate a production environment of the enterprise system;
place the test users in the recreated production environment; and
provide access to one or more user devices to control the test users in the recreated production environment.

4. The system of claim 3, wherein the computer program code, when executed by the at least one processor, further instructs the at least one processor to assign the one or more of the plurality of generated roles to the plurality of users of the enterprise system by provisioning the tested plurality of generated roles from the test users to respective users of the plurality of users of the enterprise system.

5. The system of claim 2, wherein the computer program code, when executed by the at least one processor, further instructs the at least one processor to:
recreate a production environment of the enterprise system;
place the test users in the recreated production environment;
retrieve subsequent user activity of the plurality of users of the enterprise system in the production environment; and
replay, with the corresponding test users in the recreated production environment, the subsequent user activities.

6. The system of claim 2, wherein the computer program code, when executed by the at least one processor, further instructs the at least one processor to:
recreate a production environment of the enterprise system;
place the test users in the recreated production environment; and
replay, with the corresponding test users in the recreated production environment, the historical user activity of the plurality of users of the enterprise system.

7. The system of claim 1, wherein the computer program code includes machine-learning algorithms configured to analyze the user activity data and the SoD rulesets and generate the plurality of roles.

8. The system of claim 7, wherein the machine-learning algorithms are further configured to:
analyze existing role definitions to determine naming and format conventions;
analyze SoD rulesets to determine second-level restrictions; and
generate the plurality of roles in accordance with the determined naming and format conventions and second-level restrictions.

9. The system of claim 1, wherein the computer program code, when executed by the at least one processor, further instructs the at least one processor to:
receive legacy role definitions and legacy role assignments of the plurality of users of the enterprise system;
store the legacy role definitions and legacy role assignments; and
in response to a user indication, revert the assigned roles of the plurality of users of the enterprise system to the legacy role assignments.

10. The system of claim 1, wherein the computer program code, when executed by the at least one processor, further instructs the at least one processor to:
generate an emergency repair role;
identify, from within the user activity data, one or more activities that are historically used less than a predetermined number of times; and
assign the identified one or more activities to the emergency repair role.

11. The system of claim 1, wherein automatically generating the plurality of roles includes:
naming a plurality of roles; and
assigning, based on the user activity data and the SoD rulesets, one or more activities to each of the plurality of roles.

12. The system of claim 11, wherein the computer program code, when executed by the at least one processor, further instructs the at least one processor to test the assigned one or more of the plurality of generated roles by:
identifying subsequent user activities of the plurality of users of the enterprise system in a production environment of the enterprise system; and
comparing the subsequent user activities to the assigned one or more activities of the assigned one or more of the plurality of generated roles.

13. A method including:
receiving user activity data including identification of historical user activity of a plurality of users of an enterprise system;
receiving one or more separation of duty (SoD) rulesets;
automatically generating, based on the user activity data and the SoD rulesets, a plurality of roles; and
assigning, based on the user activity data and the SoD rulesets, one or more of the plurality of generated roles to plurality of users of the enterprise system.

14. The method of claim 13 further including:
assigning, based on the user activity data and the SoD rulesets, one or more of the plurality of generated roles to a plurality of test users, respective test users of the plurality of test users corresponding to respective users of the plurality of users of the enterprise system; and
testing the plurality of generated roles assigned to the plurality of test users.

15. The method of claim 14 further including:
recreating a production environment of the enterprise system;
placing the test users in the recreated production environment; and
providing access to one or more user devices to control the test users in the recreated production environment.

16. The method of claim 15 further including assigning the one or more of the plurality of generated roles to the plurality of users of the enterprise system by provisioning the tested plurality of generated roles from the test users to respective users of the plurality of users of the enterprise system.

17. The method of claim 14 further including:
recreating a production environment of the enterprise system;
placing the test users in the recreated production environment;
retrieving subsequent user activity of the plurality of users of the enterprise system in the production environment; and
replaying, with the corresponding test users in the recreated production environment, the subsequent user activities.

18. The method of claim 13, wherein automatically generating the plurality of roles includes transforming the user activity data and the SoD rulesets into the plurality of roles.

19. The method of claim 13 further including:
generating an emergency repair role;
identifying, from within the user activity data, one or more activities that are historically used less than a predetermined number of times; and
assigning the identified one or more activities to the emergency repair role.

20. A non-transitory computer readable medium having stored thereon computer program code for executing a method comprising:
receiving user activity data including identification of historical user activity of a plurality of users of an enterprise system;
receiving one or more separation of duty (SoD) rulesets;
automatically generating, based on the user activity data and the SoD rulesets, a plurality of roles; and
assigning, based on the user activity data and the SoD rulesets, one or more of the plurality of generated roles to plurality of users of the enterprise system.
